(19) United States
(12) Patent Application Publication
(10) Pub. No.: US 2007/0045525 A1
(43) Pub. Date: Mar. 1, 2007

(54) Optical encoder and controller for the same

(75) Inventors: Ching-Hsiung Tsai, Taoyuan Hsien (TW); Jian-Da Chen, Taoyuan Hsien (TW); Meng-Chang Lin, Taoyuan-Hsien (TW); Cheng-Ping Lin, Taoyuan-Hsien (TW)

Correspondence Address: HDSL, 4331 STEVENS BATTLE LANE, FAIRFAX, VA, 22033, US

(73) Assignee: Delta electronics, Inc.

(21) Appl. No.: 11/211,621

(22) Filed: Aug. 26, 2005

(51) Int. Cl. G01J 3/50

(52) U.S. Cl. 250/231.13

(57) ABSTRACT

An optical encoder includes a controller electrically connected to an optical sensor to discriminate displacement information of a glass disc. The controller comprises a pair of analog amplifiers for amplifying quadrature periodical output signals of the optical sensor, a pair of A/D converters electrically connected to the analog amplifiers for digitalizing the output of the analog amplifiers, a pair of hysteresis comparators electrically connected to the optical sensor for performing hysteresis comparison for the output of the optical sensor, an up/down counter electrically connected to the pair of hysteresis comparators for up/down counting the output of the hysteresis comparators and a firmware unit electrically connected to the pair of A/D converters and the up/down counter for performing interpolation for the quadrature periodical output signals and counting for the hysteresis compared signals. Therefore, optical encoded result of higher resolution can be achieved.

### BACKGROUND OF THE INVENTION

1. Field of the Invention

The present invention relates to an optical encoder and a controller for the same, especially to a DSP-based optical encoder performing interpolation by inverse trigonometric function in original analog signal and counting by hysteresis comparison, thus achieving high resolution.

2. Description of Prior Art

The AC servomotor generally comprises an optical encoder wheel to sense angle information of a rotator, this angle information can be used to determine an electromagnetic field for driving stator current. Therefore, the speed of the AC servomotor can be precisely controlled. The noise of the AC servomotor can be advantageously reduced if the optical encoder wheel can provide higher resolution. However, the commercially available optical encoder wheel has limited resolution even though interpolation is used.

The conventional ways to enhance resolution for grating type optical encoder wheel includes: 1. Increasing the mark number on the optical encoder wheel. 2. Fine division by electronic skill. 3. Using different optical principle. The first method has limited effect because manufacture difficulty and diffraction phenomenon. The second method is more feasible because the mechanical structure does not need immense change. The third method needs to change the original architecture, such as using laser diode. Moreover, different optical design such as diffraction or interference are involved to enhance resolution.

The fine division for existing optical encoder includes following four types. 1. The fine division mechanism is incorporated into the optical encoder such as GPI 9220, DRC 25D, RSF MS 6X series. 2. Standalone product, such as RENISHAW RGE series, HEIDENHAIN EXE 605 and SONY MJ100/110, MJ500/600/700 Series Interpolation Module. 3. The fine division mechanism is integrated into controller card or other products such as MMI200-PC/104. 4. The fine division mechanism is integrated into motor such as Fanuc, Mitsubishi. The fine division skill can provide 4-2048 times enhancement or more, which depends on the quality of original signal and signal compensation skill.

In generally, the output signal of the optical encoder is analog sinusoidal signal and can be processed by digital scheme to obtain fine division.

The fine division method can be classified into phase fine division and amplitude fine division and which is stated in more detail hereinafter. 1. Direct Fine Division

This scheme is quadruple frequency method shown in FIG. 1. The servo motor driver generally uses A, B phase signals from the optical encoder with specific IC, PAL or GAL signals to achieve quadruple frequency.

2. Phase Fine Division with Resistor Chain

The A, B phase signals from the optical encoder are further phase-divided by resistor chain. The original signals are divided into n equal partitions by adders and subtractors. However, the amount of resistors is increased and the accuracy of the resistors is demanding when more partitions are needed. The most common partition number is around 20.

3. Composition of Resistor Chain

As shown in FIG. 2, the resistors are in serial or parallel connection, and the A, B phase signals are:
A=U₀ sin α
B=U₀ cos α

The composite signals generated from the resistor chain are:

$$\begin{matrix}{U}_{i} = A cos {β}_{i} + B sin {β}_{i} \\ = {U}_{0} ( cos {β}_{i} sin α + sin {β}_{i} cos α ) \\ = {U}_{0} sin ( α + {β}_{i} )\end{matrix}$$

$${β}_{i} = i * {360}^{°} / n$$

$$i = 1 , 2 , 3 , 4 …$$

The A, B phase signals have 90 degree phase difference and can be expressed into two orthogonal vectors (V₁, V₂) and a signal Vₖ tapped therefrom has following expression:

$$\begin{matrix}{V}_{K} = {V}_{1} + \frac{{R}_{2}}{{R}_{1} + {R}_{2}} ( {V}_{2} - {V}_{1} ) \\ = \frac{{R}_{1}}{{R}_{1} + {R}_{2}} {V}_{1} + \frac{{R}_{2}}{{R}_{1} + {R}_{2}} {V}_{2}\end{matrix}$$

$$θ = {tan}^{- 1} ( \frac{{R}_{2}}{{R}_{1}} )$$

For example, U.S. Pat. No. 5,920,494 disclosed a fine division by composition of resistor chain, wherein multiple divisions (1×, 2×, 5×, and 10×) are provided without the problem of missing pulses.

4. Amplitude Fine Division

The amplitudes of the A, B phase signals are equally divided into n partition. As shown in FIG. 3, U.S. Pat. No. 6,355,927 performs addition and subtraction to A, B phase signals of different amplitudes. The result is further processed by logic comparison for fine division

5. A/D Fine Division with Lookup Table

The phase fine division with resistor chain needs 120 resistors and 40 comparators when the division number is 20, which is cumbersome when better precision is needed. The ration of the A, B phase signals can be expanded in Taylor series to obtain phase information. A lookup table stored in ROM can be used to speed up the calculation time, as shown in FIG. 4. 6. Electronic Fine Division

As the speed of DSP and MPU is increased, the fine division scheme can be implemented by ADC with the help of DSP and MPU. The signals are actively or passively adjusted for higher resolution. The signal is compensated by orthogonal adjustment for amplitude, DC level. Part of the calculation task is off-loaded to lookup table and electronic circuit when the DSP and MPU are also used for servo control.

FIG. 5 shows an implementation of electronic fine division in parallel architecture. The ADC has 12-bit resolution for angular calculation, and the phase digitizer has 3-bit resolution for generating N and PH with the help of high-speed signal processing portion. The thus generated N and PH provide comparison base for phase quadrant for DSP. For example, PH is 1 when M is 0, 1, 2, or 3; PH is 0 when M is 0, 1, 2, or 3. N has increment of 1 when M is changed from 7 to 0.

However, the above-mentioned optical encoder still cannot exploit the operation speed of current DSP for providing better resolution.

### SUMMARY OF THE INVENTION

The present invention is intended to provide a DSP-based optical encoder performing interpolation by inverse trigonometric function in original analog signal and counting by hysteresis comparison, thus achieving high resolution.

Accordingly, the present invention provides an optical encoder and a controller for the same. The optical encoder comprises a controller for processing output signals of an optical sensor. The optical sensor generates output periodic signals with quadrature phase difference after receiving light passing a glass plate with etched pattern. The controller comprises a pair of analog amplifiers for amplifying quadrature periodical output signals of the optical sensor, a pair of A/D converters electrically connected to the analog amplifiers for digitalizing the output of the analog amplifiers, a pair of hysteresis comparators electrically connected to the optical sensor for performing hysteresis comparison for the output of the optical sensor, an up/down counter electrically connected to the pair of hysteresis comparators for up/down counting the output of the hysteresis comparators and a firmware unit electrically connected to the pair of A/D converters and the up/down counter for performing interpolation for the quadrature periodical output signals and counting for the hysteresis compared signals. Therefore, optical encoded result of higher resolution can be achieved.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the quadruple frequency method.

FIG. 2 shows the composition of resistor chain.

FIG. 3 shows the amplitude fine division.

FIG. 4 shows the A/D fine division with lookup table.

FIG. 5 shows the block diagram of electronic fine division in parallel architecture.

FIG. 6 shows a schematic view of an optical encoder according to a preferred embodiment of the present invention.

FIG. 7 is block diagram of the controller according to a preferred embodiment of the present invention.

FIG. 8 shows an operational flowchart of the firmware unit in the controller.

### DETAILED DESCRIPTION OF THE INVENTION

FIG. 6 shows a schematic view of an optical encoder 10 according to a preferred embodiment of the present invention. The optical encoder 10 mainly comprises a coherent light source 200 such as a laser lamp, a glass plate 210 with etched pattern, a photo mask 200, a light sensor 240 and a controller 100 (not shown). The glass plate 210, for example, has pattern with 2500 marks per turn. Namely, there are 2500 A, B phase signals with 90°phase difference.

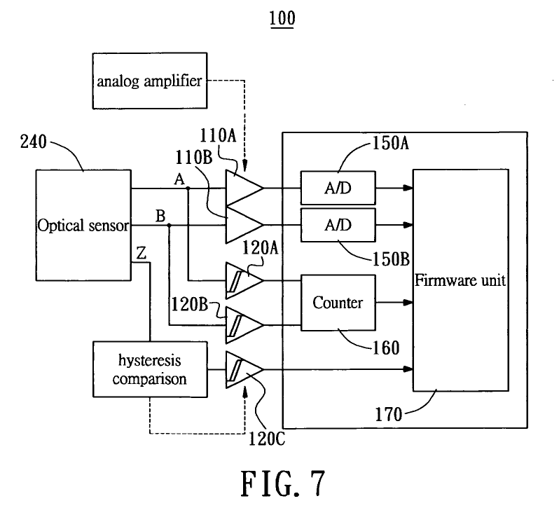

FIG. 7 is block diagram of the controller 100, which processes a detected signal from the light sensor 240 to obtain a displacement information of the glass plate 210. The controller 100 comprises a first analog amplifier 110A and a second analog amplifier 110B electrically connected to the light sensor 240, a first hysteresis comparator 120A, a second hysteresis comparator 120B and a third hysteresis comparator 120C electrically connected to the light sensor 240. Moreover, the controller 100 further comprises a first ADC (analog to digital converter) 150A and a second ADC 150B electrically connected to the first analog amplifier 110A and the second analog amplifier 110B, respectively, a counter 160 electrically connected to the first hysteresis comparator 120A and the second hysteresis comparator 120B, and a firmware unit 170 electrically connected to the first ADC 150A, the second ADC 150B, the counter 160 and the output of the third hysteresis comparator 120C.

The first analog amplifier 110A and the second analog amplifier 110B receive the A, B phase signals with 900 phase difference from the light sensor 240, namely, sin and cosine signals with following expressions:
A=U₀ sin θ
B=U₀ cos θ

The A, B phase signals with 900 phase difference, after amplification by the first analog amplifier 110A and the second analog amplifier 110B, are digitalized by the e first ADC 150A and the second ADC 150B, and then sent to the firmware unit 170 for frequency multiplying processing.

$$\frac{A}{B} = tan θ$$

$$θ = {tan}^{- 1} \frac{A}{B}$$

In above formula, the angle θ can be known by lookup table. On virtue that tan θ has period of π(−π/2 to π/2), the output signals Aₚ, Bₚ of the first hysteresis comparator 120A and the second hysteresis comparator 120B can be quadruple processed to know the angle θ is in which quadrant. The counter 160 can performing counting according to the output signals Aₚ, Bₚ of the first hysteresis comparator 120A and the second hysteresis comparator 120B. Provided that the glass plate 210 has 2500 A, B phase signals with 90° phase difference, the optical encoder 10 can provide resolution of 2500 ppr×4=10000 ppr. If there is 180 partitions additionally set for 0−π/2 for π=tan⁻¹(A/B), then the overall resolution of the optical encoder 10 is 1800000 ppr.

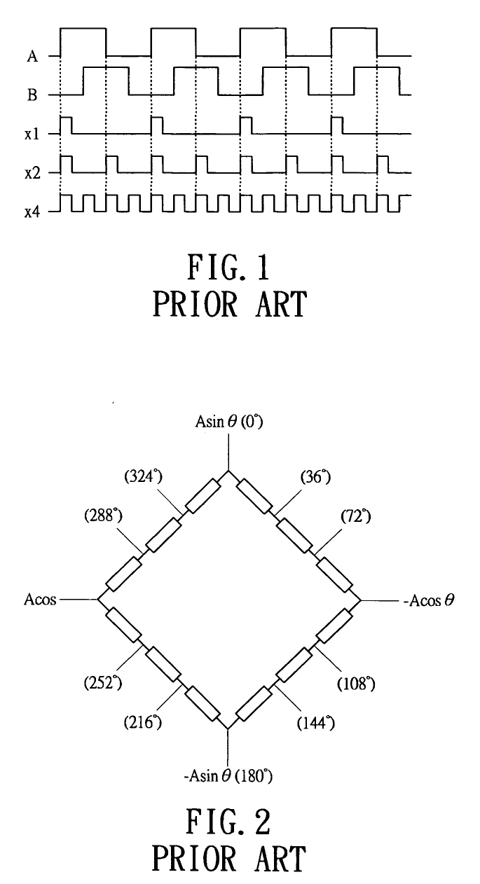

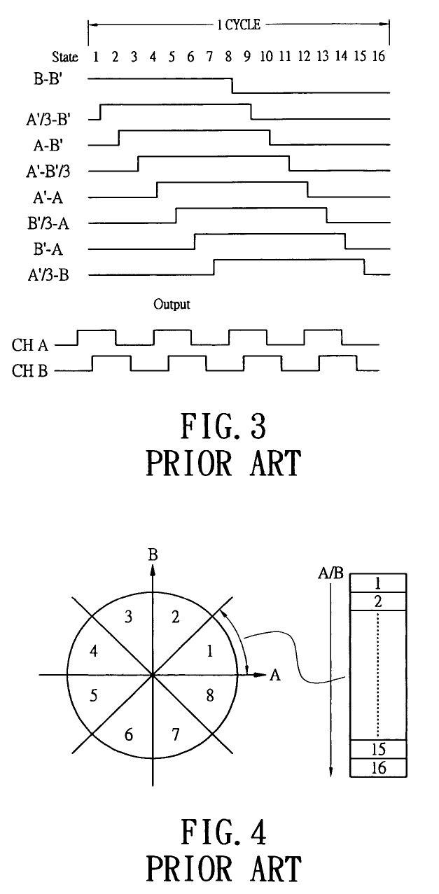

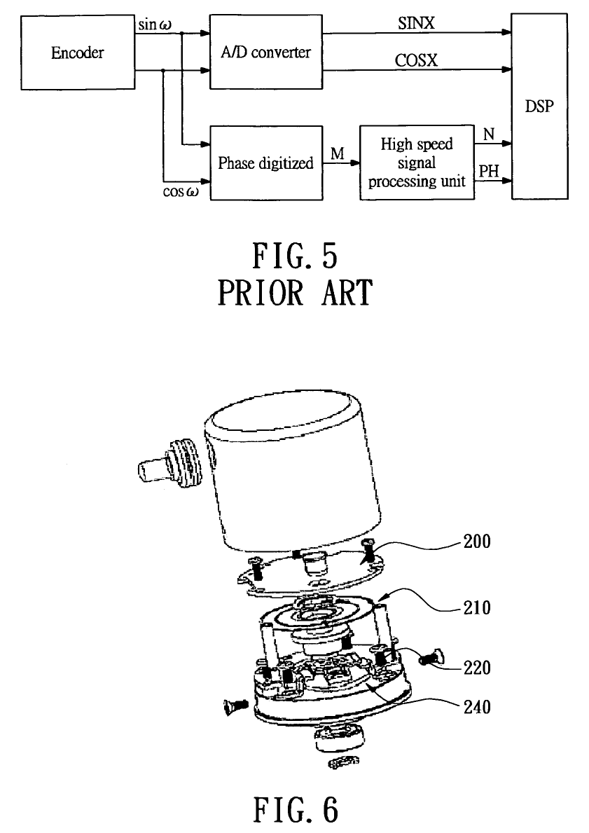

In the block diagram shown in FIG. 7, the high resolution provided by the encoder can solve the problem of position resolution at low turning speed and speed estimation. There are 2500*4 pulses per turn after the treatment of hysteresis and frequency quadrupling, similar to the waveform shown in FIG. 1. The turning speed of 10000 ppr is sufficient for high rotation speed, however, current surge at low rotation speed. To solve this problem, the first analog amplifier 110A and the second analog amplifier 110B, the first ADC 150A and the second ADC 150B are provided to process the A, B phase signals with 900 phase difference, thus enhancing resolution. Moreover, the first ADC 150A, the second ADC 150B, the counter 160 and the firmware unit 170 shown in right side of FIG. 7 can be implemented with a DSP to fully exploit the capability of DSP.

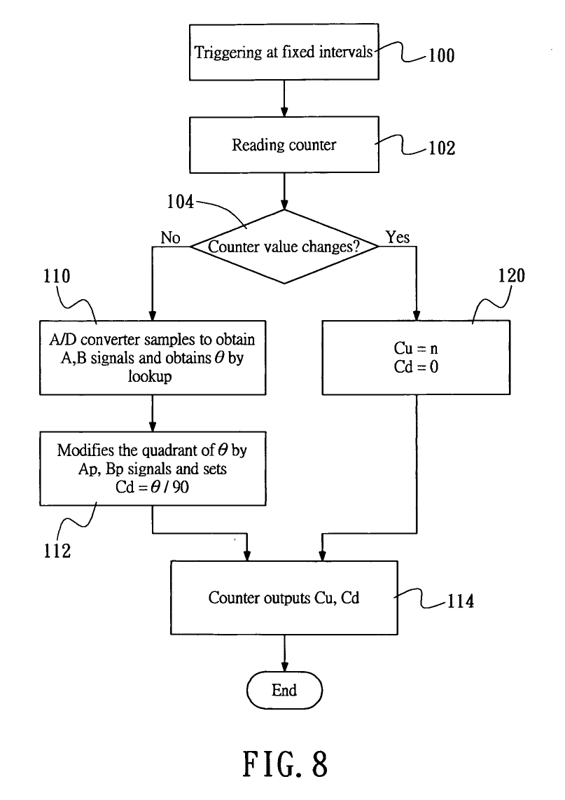

FIG. 8 shows an operational flowchart of the firmware unit 170 in the controller 100. The firmware unit 170 is triggered at predetermined timing (step 100) and then reads the output of the counter 160 (step 102) and judges whether the output from the counter 160 has changed (step 104). The output Cu of the counter 160 is set to current counting value n, and the angle θ is reset to zero, namely Cd=0 (step 120) when the output from the counter 160 has changed. The angle θ is obtained from the output of the first ADC 150A and the second ADC 150B (step 110) when the output from the counter 160 has not changed. Moreover, the quadrant for the angle 0 is modified according to the output signals Aₚ, Bₚ of the first hysteresis comparator 120A and the second hysteresis comparator 120B, namely Cd=θ/90 (step 112). Finally, the parameters Cu, Cd are sent to the firmware unit 170 by the counter 160 to obtain the displacement information of the glass plate 210.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An optical encoder, comprising:
a light source;
a glass plate with etched pattern;
a light sensor receiving a light passing the glass plate with etched pattern to generate output periodic signals with quadrature phase difference;
a controller electrically connected to the light sensor and judging a displacement of the glass plate based on the output periodic signals with quadrature phase difference from the light sensor;
wherein the controller comprises
a pair of analog amplifiers to amplify the output periodic signals with quadrature phase difference from the light sensor;
a pair of analog to digital converters (ADC) electrically connected to the pair of analog amplifiers to digitalized outputs of the pair of analog amplifiers;
a pair of hysteresis comparators electrically connected to the optical sensor for performing hysteresis comparison for the output periodic signals of the optical sensor; and
a counter electrically connected to the pair of hysteresis comparators for up/down counting output of the hysteresis comparators;
a firmware unit receiving outputs from the pair of the ADCs and the counter to obtain displacement of the glass plate.

2. The optical encoder as in claim 1, wherein the output periodic signals with quadrature phase difference are sin signals and cosine signals.

3. The optical encoder as in claim 1, wherein the firmware unit performs frequency multiplying treatment for the outputs of the ADCs.

4. The optical encoder as in claim 1, wherein the firmware unit obtain an angle θ from the displacement of the glass plate according to the outputs of the ADCs.

5. The optical encoder as in claim 4, wherein the optical encoder determines a quadrant of the angle θ from the outputs of the hysteresis comparators.

6. The optical encoder as in claim 1, further comprising a third hysteresis comparator connected between the optical sensor and the firmware unit and hysteresis comparing a turn number signal z from the optical sensor and digitalizing the turn number signal z.

7. A controller used for an optical encoder and processing output signals of an optical sensor, the optical sensor generating output periodic signals with quadrature phase difference after receiving light passing a glass plate with etched pattern; the controller comprising:
a pair of analog amplifiers to amplify the output periodic signals with quadrature phase difference from the light sensor;
a pair of analog to digital converters (ADC) electrically connected to the pair of analog amplifiers to digitalized outputs of the pair of analog amplifiers;
a pair of hysteresis comparators electrically connected to the optical sensor for performing hysteresis comparison for the output periodic signals of the optical sensor; and
a counter electrically connected to the pair of hysteresis comparators for up/down counting output of the hysteresis comparators;
a firmware unit receiving outputs from the pair of the ADCs and the counter to obtain displacement of the glass plate.

8. The controller as in claim 7, wherein the output periodic signals with quadrature phase difference are sin signals and cosine signals.

9. The controller as in claim 7, wherein the firmware unit performs frequency multiplying treatment for the outputs of the ADCs.

10. The controller as in claim 7, wherein the firmware unit obtain an angle θ from the displacement of the glass plate according to the outputs of the ADCs.

11. The controller as in claim 10, wherein the optical encoder determines a quadrant of the angle θ from the outputs of the hysteresis comparators.

12. The controller as in claim 7, further comprising a third hysteresis comparator connected between the optical sensor and the firmware unit and hysteresis comparing a turn number signal z from the optical sensor and digitalizing the turn number signal z.

13. A method for operating an optical encoder, the optical encoder comprising an optical sensor generating output periodic signals with quadrature phase difference after receiving light passing a glass plate with etched pattern; a pair of analog amplifiers to amplify the output periodic signals with quadrature phase difference from the light sensor; a pair of analog to digital converters (ADC) electrically connected to the pair of analog amplifiers to digitalized outputs of the pair of analog amplifiers; a pair of hysteresis comparators electrically connected to the optical sensor for performing hysteresis comparison for the output periodic signals of the optical sensor; and a counter electrically connected to the pair of hysteresis comparators for up/down counting output of the hysteresis comparators; the method comprising the steps of
reading outputs from the counter;
resetting an angle θ of displacement to zero when the outputs from the counter are changed;
obtaining the angle θ of displacement and modifying a quadrant of the angle θ by outputs of the hysteresis comparators when the outputs from the counter are not changed; and
outputting a counting value of the counter and the angle θ of displacement.
